(19) United States
(12) Patent Application Publication
(10) Pub. No.: US 2022/0094160 A1
(43) Pub. Date: Mar. 24, 2022

(54) DIRECT CURRENT LOAD BANK

(71) Applicant: Faith Technologies, Inc., Menasha, WI (US)

(72) Inventors: Tim John Zdrazil, Hortonville, WI (US); Dustin Robert Scaife, Menomonee Falls, WI (US)

(21) Appl. No.: 17/477,780

(22) Filed: Sep. 17, 2021

Related U.S. Application Data
(60) Provisional application No. 63/080,447, filed on Sep. 18, 2020.

(51) Int. Cl. H02J 1/14; H02J 1/00; H02J 7/00; H02J 3/38

(52) U.S. Cl. CPC H02J 1/14; H02J 1/002; H02J 2300/28; H02J 3/38; H02J 7/0068

(57) ABSTRACT

A direct current (DC) load bank system includes a DC bus having a DC bus voltage, a first interface device electrically connected to the DC bus, the interface device configured to receive DC or alternating current (AC) electrical energy from an electrical energy generating device, convert the DC or AC electrical energy to properly-rated DC electrical energy, and supply the properly-rated DC electrical energy to the DC bus, an energy storage system electrically connected to the DC bus, the energy storage system configured to supply DC electrical energy to or absorb DC electrical energy from the DC bus, a load bank electrically connected to the DC bus, the load bank configured to absorb electrical energy from the DC bus, and a facility load electrically connected to the DC bus, the facility load configured to accept electrical energy from the DC bus.

### BACKGROUND

The present application claims priority to the earlier-filed US Provisional Patent Application having Ser. No. 63/080,447, and hereby incorporates the subject matter of the provisional application in its entirety.

The disclosure hereof relates to the field of energy generation, energy storage, and the use and disposition of electrical energy in testing equipment that generates electricity. More specifically, disclosed herein are apparatuses and methods for absorbing and dispositioning the electrical energy produced during testing of generators and other equipment that generates electricity.

The electrical energy produced during testing of generators and other equipment that generates electricity is typically routed as alternating current (AC) or direct current (DC) to one or more load banks consisting of resistive or inductive loads arranged in load banks. Such load banks essentially convert the electrical energy to heat that transfers to the environment as thermal waste.

### SUMMARY

It would be advantageous to capture the electrical energy produced by the generators instead of allowing it to convert to thermal waste. The present disclosure presents a system and method for converting the generated electrical energy to a form of electrical energy that can be used.

The present disclosure is directed to a DC load bank system including a DC bus having a DC bus voltage, a first interface device electrically connected to the DC bus, the interface device configured to receive DC or AC electrical energy from an electrical energy generating device, convert the DC or AC electrical energy to properly-rated DC electrical energy, and supply the properly-rated DC electrical energy to the DC bus, an energy storage system electrically connected to the DC bus, the energy storage system configured to supply DC electrical energy to or absorb DC electrical energy from the DC bus, a load bank electrically connected to the DC bus, the load bank configured to absorb electrical energy from the DC bus, and a facility load electrically connected to the DC bus, the facility load configured to accept electrical energy from the DC bus.

In another aspect, the present disclosure is directed to a DC load bank system including a DC bus, an interface device electrically connected to the DC bus, the interface device configured to receive DC or AC electrical energy from an electrical energy generating device, convert the DC or AC electrical energy to properly-rated DC electrical energy, and supply the properly-rated DC electrical energy to the DC bus, an energy storage system electrically connected to the DC bus, the energy storage system configured to supply DC electrical energy to or absorb DC electrical energy from the DC bus, and a DC load bank electrically connected to the DC bus, the DC load bank configured to absorb electrical energy from the DC bus.

In still another aspect, the present disclosure is directed to a DC load bank system including a DC bus, an interface device electrically connected to the DC bus, the interface device configured to receive DC or AC electrical energy from an electrical energy generating device, convert the DC or AC electrical energy to properly-rated DC electrical energy, and supply the properly-rated DC electrical energy to the DC bus, a DC load bank electrically connected to the DC bus, the DC load bank configured to absorb electrical energy from the DC bus; and a facility load electrically connected to the DC bus, the facility load configured to accept electrical energy from the DC bus.

### BRIEF DESCRIPTION OF THE DRAWINGS

The foregoing and other features and aspects of the present disclosure and the manner of attaining them will become more apparent, and the disclosure itself will be better understood by reference to the following description, appended claims and accompanying drawings, where:

FIG. 1 is a block diagram representation of a DC load bank system employing a DC bus according to various aspects of the disclosure.

Repeat use of reference characters in the present specification and drawings is intended to represent the same or analogous features or elements of the present disclosure. The drawings are representational and are not necessarily drawn to scale. Certain proportions thereof might be exaggerated, while others might be minimized.

### DETAILED DESCRIPTION

Unless otherwise noted, “electrically connected” or “connected” means two devices, buses, or other components are in electrical contact such that electrical energy can be made to flow from one to the other. The two can be directly connected or connected through one or more intervening devices, buses, or other components. For example, a device electrically connected to a bus can be either directly connected, connected via a converter, inverter, regulator, or other device, or connected through a switch, for example, such that electrical energy can be made to flow from one to the other when the switch is closed.

Unless otherwise noted, “communication” and its variants mean two devices are in contact through ethernet, wireless, or any other suitable transmission technology such that control signals, data, and other information can be transferred between the devices, either directly or through one or more intervening devices.

A DC load bank system 10 is the electrical interconnection to which each of the electrical energy generating devices 30 is interconnected to allow transfer of energy. The DC load bank system 10 is scalable in that the DC load bank system 10 can accommodate one or more load banks and one or more electrical energy generating devices 30 connected via multiple modular interface points.

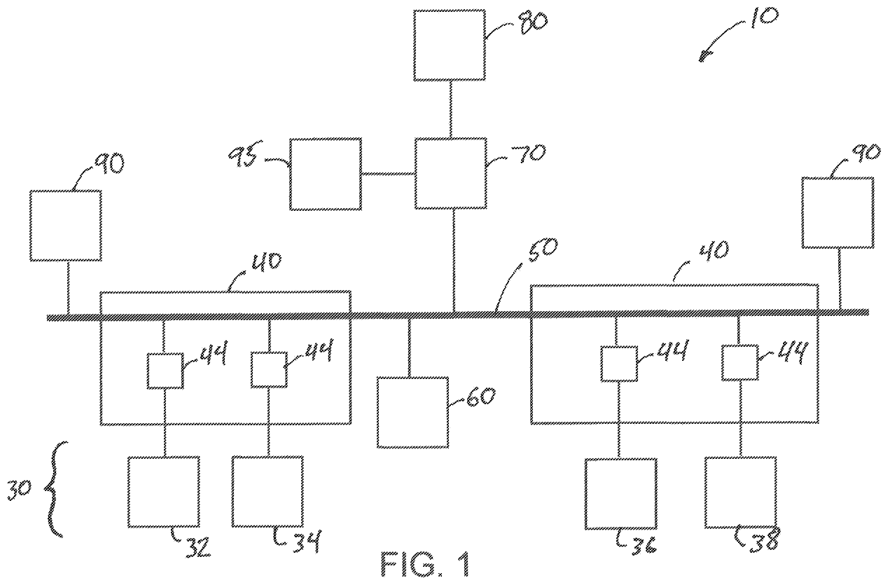

For exemplary purposes only, the basic elements of the DC load bank system 10 are illustrated in FIG. 1. It should be noted that FIG. 1 is more of a one-line electrical diagram rather than a representation of the physical placement of various devices. The physical and electrical arrangement of devices can be rearranged as necessary under specific environmental considerations as long as the function of the system is maintained.

The DC load bank system 10 can include one or more inverter stations 40, one or more DC buses 50, one or more energy storage systems 60, and one or more load banks 90.

In the illustrated aspect the DC load bank system 10 works with the output of four electrical energy generating devices 32, 34, 36, and 38. The electrical energy generating devices 30 can be generators, alternators, wind-based generators, or any other device capable of producing electrical energy such as an engine-driven welder. The electrical energy generating devices 30 are each electrically connected to an inverter station 40.

Each inverter station 40 includes one or more inverters 44 capable of converting either the DC or AC output of the electrical energy generating devices 30 into properly-rated DC electrical energy that it supplies to the DC bus 50. For example, a DC output from an electrical energy generating device 30 might be at a different voltage than that required on the DC bus 50. An intervening regulator can change the voltage from that of the DC input to that desired of the DC output. The AC to DC or DC to DC inverters 44 are interface devices that convert either a DC or an AC input to a DC output, for example, a rectification device. In other aspects of the present disclosure the interface devices can be a wire, a fuse, a switch, or any other suitable interfacing mechanism. The output of the inverters 44 is transferred to a common or primary DC bus 50 to which the inverters 44 are electrically connected.

Each inverter station 40 can be a container, a room, a trailer, a truck, or any other physical space capable of hosting the required inverters 44. The inverters 44 can be used to test various power factors of the electrical energy generating devices 30 including the range of −1 to 1. As an example, an inverter 44 can be a standard inverter manufactured by Shenzhen Sinexcel Electric Co., Ltd. In one aspect, each inverter station 40 can be a standard 8-foot by 20-foot shipping container.

The DC bus 50 can be either a single level or a multi-level DC bus. A single level bus includes a first DC rail and a second DC rail. Each DC rail can be, but is not limited to, a single terminal, multiple terminals connected by suitable electrical conductors, or a bus bar. The single level bus establishes one voltage potential between the first and second DC rails. A multi-level DC bus includes the first and second DC rails and further includes at least a third DC rail. The multi-level DC bus establishes at least two different voltage potentials between the DC rails. For example, a multi-level DC bus can include a first DC rail at a positive voltage potential such as 325 volts, a second DC rail at a neutral voltage potential, and a third DC rail at a negative voltage potential such as −325 volts. The net voltage potential between the first and the third DC rails is twice the voltage potential, or 650 volts, as the potential between either of the first or third DC rails and the neutral second DC rail. Thus, three different voltage potentials exist on the multi-level DC bus. Each converter, inverter, and regulator can connect to any of the three voltage potentials according to the requirements of the loads 80, 90, energy storage system 60, or electrical energy generating devices 30 connected to the respective interface device.

The DC load bank system 10 also includes an energy storage system 60 electrically connected to the DC bus 50. The energy storage system 60 can include one or more cells and is configured to accept DC electrical energy from the DC bus 50, store such energy in one or more forms, and deliver DC electrical energy back to the DC bus 50. The energy storage system 60 can be a battery, a fuel cell, a flow battery, pumped hydro, thermal mass, inertial mass/flywheel, super capacitors, or any other suitable energy storage device or mechanism. The energy storage system 60 is sized to accommodate the needs of the DC load bank system 10. As an example, the energy storage system 60 can include batteries manufactured by Energyport, Inc.

The DC bus 50 can be configured to supply electrical energy to facility loads 80, to which the DC bus 50 is electrically connected. Where facility loads 80 require AC electrical energy, an electrically connected and intervening converter 70 can be used to convert DC electrical energy from the DC bus 50 to the AC electrical energy required by facility loads 80. In another aspect of the present disclosure, the DC load bank system 10 can also supply AC electrical energy to a utility grid 95, to which the converter 70 can be electrically connected.

The converter 70 is an interface device that converts a DC input to an AC output. Preferably, each converter 70, inverter 44, and regulator is also configured between an on and an off mode, where in the on mode power or energy transfer is allowed therethrough, and in the off mode power or energy transfer therethrough is disabled. Alternatively, a switch can be connected between the DC bus 50 and any converter, inverter, and regulator, and/or at the output of any converter, inverter, and regulator, or combinations thereof. The switch in this case is within the semiconductor device functioning as the converter, regulator, or inverter, and these components are also able to be physically turned off by switching a contactor internal thereto, or just disabling the switching functions therein while the device remains powered, enabling fast response times in the event of a change in conditions requiring a fast transient response.

The DC load bank system 10 also includes one or more load banks 90. Each load bank 90 is electrically connected to the DC bus 50 such that electrical energy can be transferred from the DC bus 50 to the load bank 90. Each load bank 90 can include if needed a DC/DC regulator that converts the DC voltage of the DC bus 50 to an appropriate DC voltage for the load bank 90. In another aspect, each load bank 90 can include a DC/AC converter that converts the DC voltage of the DC bus 50 to the AC voltage appropriate for an AC load bank. In other aspects, each load bank 90 can be similar to load banks in current systems in that a load bank 90 acts to absorb electrical energy and convert that electrical energy to heat through one or more resistors, thereby dissipating the electrical energy. For example, a load bank 90 can include 1MW, 2MW, and/or 4MW permanent or mobile resistive DC load banks manufactured by ASCO.

Every electrical connection between devices can include any appropriate inverters, converters, regulators, switches, connectors, conductors, insulators, cabinets, ducts, controllers, sensors, meters, and any other equipment necessary for the proper operation, control, and monitoring of the system and testing of the electrical energy generating devices 30. Those of ordinary skill in the art, for example, will recognize that a bidirectional AC to DC converter acts similarly but in reverse to a bidirectional DC to AC inverter and the two terms are sometimes used interchangeably. Further, throughout the examples and alternatives disclosed herein, one of ordinary skill in the art will know to select the appropriate interface device depending on the power conversion, if any, needed and the nature of the electrical energy on both sides of the interface device.

For example, a regulator can be useful under certain circumstances, such as between the DC bus 50 and the energy storage system 60. A regulator is an interface device that converts a DC input at a first voltage potential to a DC output at a second voltage potential. This can be a semiconductor switching and regulating device or a meter and a feedback loop at a connection. In this regulator configuration, energy and power flow through the regulator is based on adjustment of a DC operating voltage band on at least one of the two connections to the regulator, and, based on the actual bus voltage, current flows in one or the other direction. A DC bus regulator can be a direct connection with an electricity meter providing feedback to a controller with respect to the passage of electricity therethrough. The regulator refers to a power control and conversion device that is configured to enable changing the voltage at the input thereof to a different voltage at the output thereof and can be used with respect to a bus.

Each of the interface devices includes similar fundamental components. The converter, inverter, and regulator include a power electronics section configured to convert the voltage and/or current present at the input to a different voltage and/or current present at the output. The power electronics section includes multiple power electronic devices, such as transistors, silicon-controlled rectifiers (SCRs), thyristors, and the like that are controlled by switching signals to selectively conduct the voltage and/or current between the input and the output of the interface device.

One or more sensors can be provided at the input to measure a current and/or voltage level at the input and provide signals to a control unit. One or more sensors can be provided at the output to measure a current and/or voltage level at the output and provide signals to the processor. Either the sensors at the input or the sensors at the output monitor the voltage level present on the DC bus 50, depending on whether the input or the output is connected to the DC bus 50, and the other sensors monitor the voltage level of a loads 80, 90, energy storage system 60, electrical energy generating devices 30, and the DC bus 50 to which the interface device is connected.

The control unit of each interface device preferably includes a processor capable of executing a series of instructions, or a module, to send control signals to the power electronic devices and memory in communication with the processor for storing the module capable of executing on the processor. The signals from the sensors corresponding to the voltage and/or current at the input and output of the interface device are read by the module executing on the processor. The module outputs the switching signals to the power electronic devices to regulate power flow through the device. Alternately, the control unit can include dedicated control hardware to generate switching signals and regulate power flow through the device. For example, a boost converter, as is known in the art, can be used to convert a first DC voltage level to a higher, second DC voltage level.

The capacities and connections of the devices described herein depend on the expected output and number of electrical energy generating devices 30. Larger capacity devices and/or a larger number of devices can be employed if a larger energy handling capacity is desired. Additional inverters 44, inverter stations 40, energy storage systems 60, load banks 90, and DC buses 50 can be added and interconnected as necessary to handle expected energy levels. For example, a DC load bank system 10 configured to accommodate simultaneously testing four generators might require three inverter stations including 20 inverters, three batteries each absorbing and supplying 1MVA, one 1MW DC load bank, and one 4MW DC load bank.

In use of the DC load bank system 10, DC or AC electrical energy generated by the electrical energy generating devices 30 is converted to properly-rated DC electrical energy by the inverters 44, thus energizing the DC bus 50. The DC electrical energy can supply facility loads 80 through converter 70, energy storage system 60, and/or load banks 90 depending on the control scheme chosen and the needs of the facility loads 80. The energy storage system 60 can absorb electrical energy from the DC bus 50 or supply electrical energy to the DC bus 50, essentially providing a leveling function to the DC bus 50. Any electrical energy not sent to the facility loads 80, the energy storage system 60, or the grid 95 can be shunted to the load banks 90.

Each inverter 44, converter 70, or other interface device can be configured to operate with the DC bus 50 based on DC voltages selected within a range to maintain stability on the DC bus 50. The interface devices can include settable minimum and maximum voltages to establish a voltage band for passage of DC electricity therethrough with respect to the DC bus 50. Power and energy can be consumed by facility loads 80, energy storage systems 60, and/or load banks 90 to achieve the power-energy balance needed to maintain the voltage on the DC bus 50 within the required or set voltage ranges. This operating paradigm is set forth in U.S. Pat. No. 8,008,808, which is incorporated herein by reference in its entirety to the extent it does not conflict herewith.

The performance and electrical energy flow of the DC load bank system 10 can be controlled by the equipment and processes described in U.S. patent application Ser. No. 16/528,515, which is incorporated herein by reference in its entirety to the extent it does not conflict herewith.

Within the DC load bank system 10, in one aspect a centralized monitoring and controller station tracks the drawing and supply of energy/power by component. The station can be user settable to establish whether to take energy from or supply energy to components. The DC load bank system 10 can also include local controllers. The centralized station and/or the local controller can be autonomous, in communication with the centralized station and/or other local controllers, or operate in any two or more of these communication modes at different times.

The control system run by software can perform the tasks of adjusting the internal voltage of the DC bus 50 as appropriate, controlling the DC load banks 90 for proper energy management, and managing total energy coming in from the electrical energy generating devices, going out to the facility load 80 and the load banks 90, and transferring to and from the energy storage system.

Multiple exemplary systems with alternatives and varied aspects have been described herein. Various other systems including different combinations of components, generating sources, buses, storage devices, and the like can be used without deviating from the scope of the disclosure. It is further contemplated that multiple systems can each include a separate controller to regulate the components within their respective system, but the controllers can further be in communication with each other to regulate power flow between systems.

While the disclosure has been described in detail with respect to specific aspects thereof, it will be appreciated that those skilled in the art, upon attaining understanding of the foregoing will readily appreciate alterations to, variations of, and equivalents to these aspects. Accordingly, the scope of the present disclosure should be assessed as that of the appended claims and any equivalents thereto. Additionally, all combinations and/or sub-combinations of the disclosed aspects, ranges, examples, and alternatives are also contemplated.

What is claimed:

1. A direct current (DC) load bank system comprising:
a DC bus having a DC bus voltage;
a first interface device electrically connected to the DC bus, the interface device configured to receive DC or alternating current (AC) electrical energy from an electrical energy generating device, convert the DC or AC electrical energy to properly-rated DC electrical energy, and supply the properly-rated DC electrical energy to the DC bus;
an energy storage system electrically connected to the DC bus, the energy storage system configured to supply DC electrical energy to or absorb DC electrical energy from the DC bus;
a load bank electrically connected to the DC bus, the load bank configured to absorb electrical energy from the DC bus; and
a facility load electrically connected to the DC bus, the facility load configured to accept electrical energy from the DC bus.

2. The DC load bank system of claim 1, wherein the energy storage system is a battery.

3. The DC load bank system of claim 1, wherein the first interface device is an inverter.

4. The DC load bank system of claim 1, wherein the load bank is a DC load bank.

5. The DC load bank system of claim 1, further comprising a second interface device electrically interposed between the DC bus and the facility load.

6. The DC load bank system of claim 5, wherein the second interface device is configured to accommodate an electrical connection to a utility grid.

7. The DC load bank system of claim 5, wherein the second interface device is a converter.

8. The DC load bank system of claim 1, wherein the electrical energy generating device is a generator.

9. The DC load bank system of claim 1, wherein the electrical energy generating device is an engine-driven welder.

10. The DC load bank system of claim 1, wherein the electrical energy generating device is an alternator.

11. The DC load bank system of claim 1, wherein the electrical energy generating device is a wind generator.

12. The DC load bank system of claim 1, further comprising a controller configured to adjust DC bus voltage.

13. The DC load bank system of claim 1, further comprising a controller configured to control the load bank.

14. The DC load bank system of claim 1, further comprising a controller configured to manage electrical energy across the electrical energy generating device, the facility load, the load bank, and the energy storage system.

15. A direct current (DC) load bank system comprising:
a DC bus;
an interface device electrically connected to the DC bus, the interface device configured to receive DC or alternating current (AC) electrical energy from an electrical energy generating device, convert the DC or AC electrical energy to properly-rated DC electrical energy, and supply the properly-rated DC electrical energy to the DC bus;
an energy storage system electrically connected to the DC bus, the energy storage system configured to supply DC electrical energy to or absorb DC electrical energy from the DC bus; and
a DC load bank electrically connected to the DC bus, the DC load bank configured to absorb electrical energy from the DC bus.

16. The DC load bank system of claim 15, further comprising a second interface device electrically connected to the DC bus, wherein the second interface device is configured to accommodate an electrical connection to a utility grid.

17. The DC load bank system of claim 15, further comprising a controller configured to manage electrical energy across the electrical energy generating device, the DC load bank, and the energy storage system.

18. A direct current (DC) load bank system comprising:
a DC bus;
an interface device electrically connected to the DC bus, the interface device configured to receive DC or alternating current (AC) electrical energy from an electrical energy generating device, convert the DC or AC electrical energy to properly-rated DC electrical energy, and supply the properly-rated DC electrical energy to the DC bus;
a DC load bank electrically connected to the DC bus, the DC load bank configured to absorb electrical energy from the DC bus; and
a facility load electrically connected to the DC bus, the facility load configured to accept electrical energy from the DC bus.

19. The DC load bank system of claim 18, further comprising a second interface device electrically interposed between the DC bus and the facility load, wherein the second interface device is configured to accommodate an electrical connection to a utility grid.

20. The DC load bank system of claim 18, further comprising a controller configured to manage electrical energy across the electrical energy generating device, the facility load, and the DC load bank.
